(19) United States
(12) Patent Application Publication
(10) Pub. No.: US 2018/0077345 A1
(43) Pub. Date: Mar. 15, 2018

(54) PREDICTIVE CAMERA CONTROL SYSTEM AND METHOD

(71) Applicant: CANON KABUSHIKI KAISHA, Tokyo (JP)

(72) Inventor: Belinda Margaret Yee, Balmain (AU)

(21) Appl. No.: 15/262,798

(22) Filed: Sep. 12, 2016

(51) Int. Cl. H04N 5/232; H04N 5/247; G06K 9/00

(52) U.S. Cl. CPC H04N 5/23222; H04N 5/247; G06K 9/00604; H04N 5/23296; H04N 5/23206

(57) ABSTRACT

A computer-implemented method and system of selecting a camera angle is described. The method comprises determining a visual fixation point of a viewer of a scene using eye gaze data from an eye gaze tracking device; detecting, from the eye gaze data, one or more saccades from the visual fixation point of the viewer, the one or more saccades indicating a one or more regions of future interest to the viewer; selecting, based on the detected one or more saccades, a region of the scene; and selecting a camera angle of a camera, the camera capturing video data of the selected region using the selected angle.

### TECHNICAL FIELD

The present invention relates a system and method for predictive camera control. For example, a method for selecting an angle of a camera in a virtual camera arrangement or selecting a camera from a multi-camera system.

### BACKGROUND

Current methods of event broadcasts, for example sports broadcasts, consist primarily of pre-set shots from stationary and mobile cameras operating outside or on top of a field. Standard camera types used in sports broadcasts include stationary pan-tilt-zoom cameras (PTZ), dolly cameras on rails which run along the edge of the field, boom cameras on long arms give a limited view over the field, mobile stabilized cameras for the sideline and end lines and overhead cameras on cable systems. The cameras are positioned and pre-set shots are selected based on experience of typical game-play and related action. For maximum coverage and ease of storytelling a director will assign a number of camera shots to each camera operator, for example a dolly camera operator may be tasked with tracking play along the sideline using either mid or close up shots. All camera feeds are relayed into a broadcast control room. A director determines which sequence of camera feeds will compose the live broadcast. The director selects camera feeds depending on which one best frames the action and how the director wishes to tell the story. The director uses cameras shooting at different angles to build toward an exciting moment for example, by transitioning from a wide shot to a tracking shot to a close up. Multiple camera shots are also used in replays to better describe a past action sequence by giving different views of the action and by presenting some shots in slow-motion.

The current method of broadcasting sport has evolved within the constraints of current camera systems and to accommodate the requirements from TV audiences. A problem with current systems of pre-set cameras and shots is that the current systems cannot always provide the best shot of the action and cannot respond quickly to changes in the action. Sports such as soccer (football), are high paced with dramatic changes in the direction and location of action on field. The slow response of physical cameras and operators makes capturing fast paced action difficult. As a work-around, the director may use wide shots when dramatic changes in action occur because the director does not have a camera in an appropriate location, ready to frame a mid or close up shot. Wide shots are necessary as wide shots provide context but are less exciting than mid or close shots where the TV audience can see the expressions on players' faces or the interaction between players.

The limitations of physical camera setups inhibit not only the broadcasters' ability to respond to large location based changes, but also to respond to smaller localised changes. For example, players routinely turn around on field. In this instance a player may initially have been well framed, but once the player turns around their body may occlude their face, the ball and the direction of play. Seeing the back of a player is not as informative as a front or side view of the player. A front or side view can include the player's current location, oncoming opponents and the probable destination of the ball when it is passed. There are usually not enough cameras in current broadcast systems to capture all angles of play. Similarly in locations relating to security surveillance or a theatre, there may not be enough cameras to capture relevant person or events from a perspective of a viewer.

A particular problem with current systems of broadcasting sport, for example, is that camera shots are selected in reaction to the action on the field. The director is not able to predict what will happen in the current action sequence or where the next action sequence will take place. One known method describes a method for generating virtual camera views in a manner which pre-empts how the current action sequence will develop. The known method identifies objects with attached sensors e.g., the ball, determines characteristics of the ball such as trajectory, and places a virtual camera view pre-emptively to film the ball as it moves. The known method is able to predict how the current action sequence will develop but is not able to determine where the next action sequence will take place.

Another known method uses information about regions of interest based on gaze data collected from multiple users. For example, if many spectators in a sporting area are looking or gazing in a particular direction, then that region is determined as a region of interesting action and camera shot can be selected to capture action from that region. The method using information about regions of interest uses gaze direction acquired from head mounted displays (HMDs) to identify and prioritise points of interest. The method using information about regions of interest may in some instances be used for generating heat maps or for displaying augmented graphics on the players and field. The disadvantage of the method using information about regions of interest is that the scene can only be captured after the “action” has started. In situations of a fast paced action, it may not be possible to capture the action in time due to the inherent latency of the system.

### SUMMARY

It is an object of the present invention to substantially overcome, or at least ameliorate, one or more disadvantages of existing arrangements.

One aspect of the present disclosure provides a computer-implemented method of selecting a camera angle, the method comprising: determining a visual fixation point of a viewer of a scene using eye gaze data from an eye gaze tracking device; detecting, from the eye gaze data, one or more saccades from the visual fixation point of the viewer, the one or more saccades indicating a one or more regions of future interest to the viewer; selecting, based on the detected one or more saccades, a region of the scene; and selecting a camera angle of a camera, the camera capturing video data of the selected region using the selected angle.

In some aspects, the visual fixation point is determined by comparing eye gaze data of the viewer captured from the eye gaze tracking device and video data of the scene captured by the camera.

In some aspects, the detected saccades are used to determine a plurality of regions of future interest and selecting the region relates to selecting one or more of the plurality of regions of interest.

In some aspects, selecting the camera angle further comprises selecting the camera from a multi-camera system configured to capture video data of the scene.

In some aspects, the scene is of a game and selecting the region of the scene based on the one or more saccades comprises prioritising the one or more regions of future interest according to game plays detected during play of the game.

In some aspects, the scene is of a game and selecting the region of the scene comprises prioritising the one or more regions of future interest based upon one or more of standard game plays associated with players of the game, fitness of a team playing the game or characteristics of opponents marking players of the game.

In some aspects, the method further comprises determining the plurality of future points of interest based upon determining a direction of each of the one or more saccades,

Another aspect of the present disclosure provides a computer-implemented method of selecting a camera of a multi-camera system configured to capture a scene, the method comprising: detecting a visual fixation point of a viewer of the scene and one or more saccades of the viewer relative to the visual fixation point using eye gaze data from an eye gaze tracking device; determining an object of interest in the scene based on at least the detected one or more saccades of the viewer, the object of interest being determined to have increasing relevance to the viewer of the scene; and selecting a camera of the multi-camera system, the selected camera having a field of view including the determined object of interest in the scene, the camera capturing video data of the determined object of interest.

In some aspects, the method further comprises determining trajectory data associated with the determined object of interest, wherein the camera of the multi-camera system is selected using the determined trajectory data.

In some aspects, the method further comprises determining based on the determined object of interest, and augmenting the video data with the graphical content.

In some aspects, selecting the camera of the multi-camera system comprises selecting at least one camera of the multi-camera system and generating a virtual camera view using the selected at least one camera.

In some aspects, selecting the camera of the multi-camera system comprises determining a plurality of virtual camera views, the virtual camera views generated by the cameras of the multi-camera system; and prioritising the plurality of virtual camera views based upon proximity of each virtual camera view relative to the determined object of interest.

In some aspects, selecting the camera of the multi-camera system comprises determining a plurality of virtual camera views, the virtual camera views generated by the cameras of the multi-camera system; and prioritising the plurality of virtual camera views based on an angle of each virtual camera view relative to the object of interest.

In some aspects, the camera is selected based on time required to re-frame the camera to capture video data of the determined object of interest

In some aspects, the selecting the camera of the multi-camera system comprises selecting a setting of the camera based upon the determined object of interest.

Another aspect of the present disclosure provides a computer readable medium having a program stored thereon for selecting a camera angle, the program comprising: code for determining a visual fixation point of a viewer of a scene using eye gaze data from an eye gaze tracking device; code for detecting, one or more saccades from the visual fixation point of the viewer, the one or more saccades indicating a one or more regions of future interest to the viewer; code for selecting, based on the detected one or more saccades, a region of the scene; and code for selecting a camera angle of a second camera, the camera capturing video data of the selected region using the selected angle.

Another aspect of the present disclosure provides apparatus for selecting a camera angle, the apparatus configured to: determine a visual fixation point of a viewer of a scene using eye gaze data from an eye gaze tracking device; detect, from the eye gaze tracking data, one or more saccades from the visual fixation point of the viewer, the one or more saccades indicating a one or more regions of future interest to the viewer; select, based on the detected one or more saccades, a region of the scene; and select a camera angle of a camera, the camera capturing video data of the selected region using the selected angle.

Another aspect of the present disclosure provides a system, comprising: an eye gaze tracking device for detecting eye gaze data of a viewer of a scene; a multi-camera system configured to capture video data of the scene; a memory for storing data and a computer readable medium; and a processor coupled to the memory for executing a computer program, the program having instructions for: detecting, using the eye gaze tracking data, a visual fixation point of the viewer and one or more saccades of the viewer relative to the visual fixation point; determining an object of interest in the scene based on at least the detected one or more saccades of the viewer, the object of interest being determined to have increasing relevance to the viewer of the scene; and selecting a camera of the multi-camera system, the selected camera having a field of view including the determined object of interest in the scene, the second camera capturing video data of the determined object of interest.

### BRIEF DESCRIPTION OF THE DRAWINGS

One or more embodiments of the invention will now be described with reference to the following drawings, in which:

FIG. 1A is a diagram of a system for selecting a camera;

FIGS. 1B and 1C form a schematic block diagram of a general purpose computer system upon which arrangements described can be practiced;

FIG. 2 shows a method of selecting a camera;

FIG. 3 shows examples of fixations and saccades;

FIG. 4 shows examples of future points of interest;

FIG. 5 shows example positioning of virtual camera fields of view;

FIG. 6 shows presentation of augmented content in footage captured by a selected camera;

FIG. 7 shows positioning of a virtual camera view from one physical camera;

FIG. 8 shows positioning of a virtual camera view from multiple physical cameras;

FIG. 9 shows a future point of interest; and

FIG. 10 shows an example of prioritisation of future points of interest.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

In the arrangements described, one or more viewers at the sport stadium are wearing head mounted displays. The head mounted displays track the viewers' gaze data. The gaze data identifies fixations (when the eye stays still) and saccades (rapid eye movements between fixations). While watching the game, the viewers' eyes will track the game play with saccades and fixations. At times however eyes of one or more of the viewers will have saccades and fixations which do not track the game play. The divergent saccades may be predictive saccades or may be due to other factors such as viewer distraction.

Predictive saccades can be distinguished from other saccades by specific attributes such as reduced speed, and can be characterised by an associated velocity profile when compared to velocity profiles of non-predictive or random saccades. Predictive saccades prepare the brain for a next action in a current task, for example, turning the head. Predictive saccades indicate where the viewer predicts the viewer's next or future point of interest or action will be. The arrangements described use predictive saccades to prioritise possible next future action events using an example game being played on a sporting field e.g., who will a player kick a ball to, out of all the players available to receive the ball. Further, the arrangements described use the prediction of the possible future action to adjust a camera angle to capture the action in time.

The predictive saccades of experts are more accurate and have lower latency than the predictive saccades of novices when playing or watching sports. Accordingly, some of the arrangements described use saccade data from expert viewers such as commentators.

The arrangements described relate to the predictive saccade direction pointing to possible future points of interest in the game play. When these points of interest are pre-emptively identified a suitable camera nearby can be selected and re-framed in preparation for action at that point of interest. Alternatively a virtual camera view can be generated to frame the point of interest before the action sequence occurs.

Some of the arrangements described use predictive saccade data to identify possible future points of interest then select one or more real cameras or position virtual camera views to get the best shot of the action.

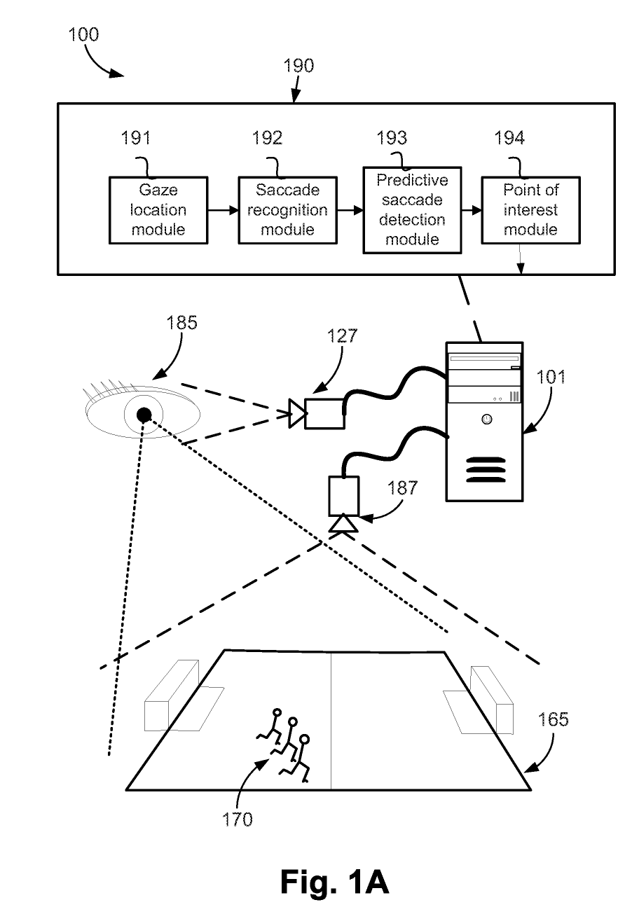

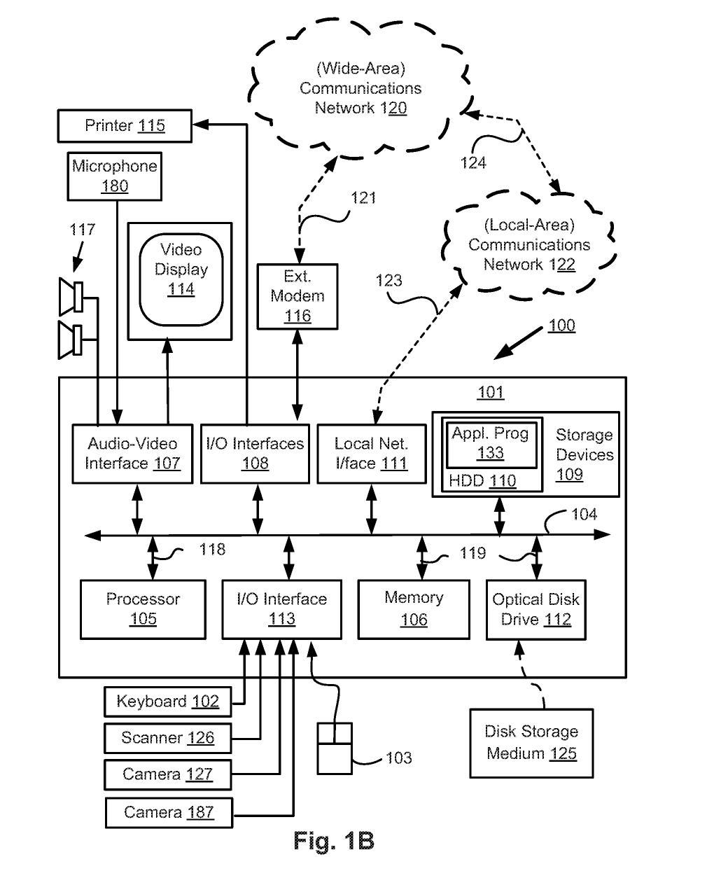

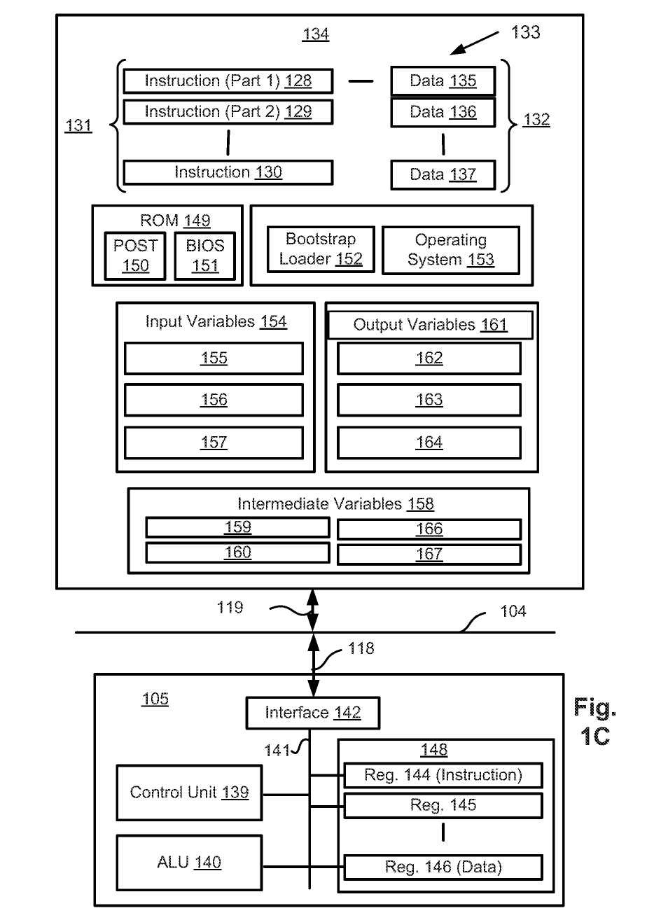

FIG. 1A is a diagram of a predictive camera selection system 100 on which the arrangements described may be practiced. In the predictive camera selection system 100, an eye gaze tracking camera 127 is used to track changes in a gaze direction of a viewer's eye 185. The eye gaze data is transmitted to a computer module 101. The eye gaze data from the viewer's eye 185 includes information relating to eye movement characteristics such as saccades. Saccades are rapid eye movements. The eye gaze data also includes information relating to fixations, being periods when the eye is stationary. The eye gaze data also includes information relating to other characteristics including direction, and preferably, peak velocity and latency of the saccades. The eye movement characteristics included in the eye gaze data are analysed by a predictive saccade module 193.

The predictive camera positioning system 100 also includes a second camera, 187, configured to capture video footage of a target location 165, such as a playing field or stadium, and as target objects of interest 170 such as players, balls, goals and other physical objects on or around the target location 165. The target objects 170 are objects involved in a current action sequence.

The system 100 includes a point of interest prediction software architecture 190. The software architecture 190 operates to receive data from the eye gaze tracking camera 127 and the camera 187. The point of interest prediction software architecture 190 consists of a gaze location module 191. The gaze location module 191 uses data from the eye gaze tracking camera 127 to identify the viewer's eye (185) gaze location. The point of interest prediction software architecture 190 also consists of a saccade recognition module 192. The saccade recognition module 192 uses data from the eye gaze tracking camera 127 to identify saccades, as distinct from fixations.

The point of interest prediction software architecture 190 also comprises of a predictive saccade detection module 193 which uses data from the eye gaze tracking camera 127 and the saccade recognition module 192 to isolate predictive saccades and identify key predictive saccade characteristics such as direction, velocity and latency. The point of interest prediction software architecture 190 also comprises a point of interest module 194. The point of interest module 194 estimates one or more future points of interest by using data from the camera 187 and predictive saccade characteristics from the predictive saccade detection module 193.

The arrangements described relate to camera selection and positioning, and more particularly to a system and method for automatic predictive camera positioning to capture a most appropriate camera shot of future action sequences at a sports game. Selecting a camera in some arrangements relates to controlling selection of a camera parameter. The predictive camera positioning described is based on predictive saccades of viewers at watching the game. As the predictive saccades of expert viewers are more accurate than novice viewers, some arrangements described hereafter use the saccades of commentators and other expert viewers at the sports game.

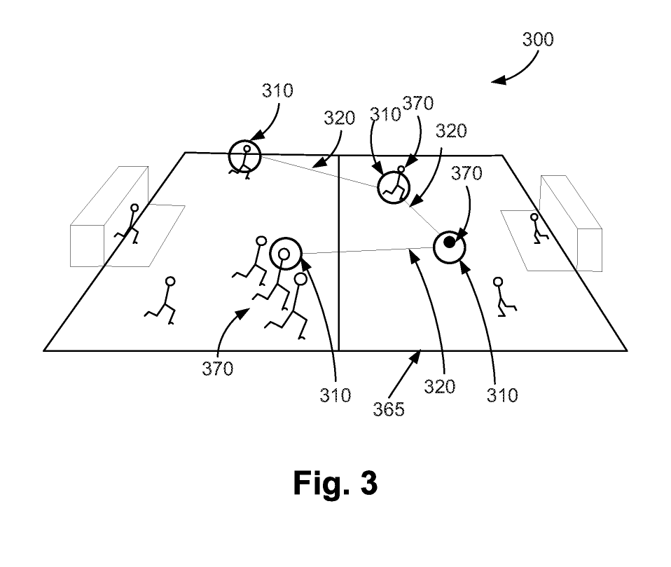

FIG. 3 shows a scene 300 including a target location 365 (similar to the target location 165 of FIG. 1A) and a plurality of target objects 370 (similar to the target objects of interest 170 of FIG. 1A). In the example of FIG. 3, the target location 365 is a sports field and the target objects 370 are a number of players and a ball. Humans look at scenes with a combination of saccades and fixations. Examples 320 representing saccades and examples 310 relating to fixations are shown in the scene 300. The fixations 310 relate to moments when the eye is stationary and is taking in visual information such as the target objects 370 (for example players or the ball). A subject of a fixation in a scene, also referred to as a visual fixation point, relates to a location or object of the scene. For example, one of the objects 370 upon which the viewer's gaze is directed during a fixation movement forms a visual fixation point of the scene. The fixations 310 are depicted in FIG. 3 as circles around some of the fixation points or objects of interest 370.

The saccades 320 relate to rapid eye movements relative to the fixations 310 during which the eye is not taking in visual data. In FIG. 3, the saccades 320 are shown as eye movements between visual fixation points in the scene 300. and are depicted graphically as lines between the target objects 370 of the visual fixation points 310. The centre of a retina known as a fovea provides the highest resolution image in human vision, however the fovea accounts for only 1-2 degrees of human vision. For this reason the saccades 320 relate to movement of the fovea around rapidly, to get a higher resolution image of the environment 300.

There are two general categories of saccade, referred to as reflexive and volitional saccades. Reflexive saccades occur when the eye is being repositioned toward visually salient parts of the scene, for example high contrast or colourful objects. The second type of saccades, volitional saccades, occur when the eye is being moved to attend to objects or parts of the scene which are relevant to the viewer's current goal or task. For example, if a user is looking for her green pencil, her saccades will move toward green objects in the scene rather than visually salient objects. Reflexive saccades are bottom-up responding to the environment. Volitional saccades are top-down reflecting the viewer's current task.

Predictive saccades, also known as anticipatory saccades, are one type of volitional saccade used in the arrangements described. Predictive saccades help prepare the human brain for action and are driven by the viewer's current task. Predictive saccades tend toward locations in an environment where a next step of the viewer's task takes place. For example, predictive saccades may look toward the next tool required in a task sequence or may look toward an empty space where the viewer expects the next piece of information will appear. Accordingly, predictive saccades pre-empt changes in the environment that are relevant to the current task, and indicate regions of future interest to the viewer. Predictive saccades can have negative latencies, that is the predictive saccades can occur up to −300 ms before an expected or remembered visual target has appeared. One study (Smit, Arend C; “A quantitative analysis of the human saccadic system in different experimental paradigms;” (1989).) describes how a batsman's gaze deviates from smooth pursuit of the cricket ball trajectory to pre-empt the ball's future bounce location. The Smit study explains that the bounce location is important to determining the post bounce trajectory of the ball, which explains why the batsman's gaze pre-emptively moves there. The Smit study also found that expert batsmen are better than novices at reacting to ball trajectory, and proposes that expert batsmen react better than novice due to differences predictive saccades.

The arrangements described use predictive saccades to pre-emptively select or position a camera angle to capture the action.

FIGS. 1B and 1C depict a general-purpose computer system 100, upon which the various arrangements described can be practiced.

As seen in FIG. 1B, the computer system 100 includes: a computer module 101; input devices such as a keyboard 102, a mouse pointer device 103, a scanner 126, cameras 127 and 187, and a microphone 180; and output devices including a printer 115, a display device 114 and loudspeakers 117. An external Modulator-Demodulator (Modem) transceiver device 116 may be used by the computer module 101 for communicating to and from a communications network 120 via a connection 121. The communications network 120 may be a wide-area network (WAN), such as the Internet, a cellular telecommunications network, or a private WAN. Where the connection 121 is a telephone line, the modem 116 may be a traditional “dial-up” modem. Alternatively, where the connection 121 is a high capacity (e.g., cable) connection, the modem 116 may be a broadband modem. A wireless modem may also be used for wireless connection to the communications network 120.

The computer module 101 typically includes at least one processor unit 105, and a memory unit 106. For example, the memory unit 106 may have semiconductor random access memory (RAM) and semiconductor read only memory (ROM). The computer module 101 also includes an number of input/output (I/O) interfaces including: an audio-video interface 107 that couples to the video display 114, loudspeakers 117 and microphone 180; an I/O interface 113 that couples to the keyboard 102, mouse 103, scanner 126, cameras 127 and 187 and optionally a joystick or other human interface device (not illustrated); and an interface 108 for the external modem 116 and printer 115. In some implementations, the modem 116 may be incorporated within the computer module 101, for example within the interface 108. The computer module 101 also has a local network interface 111, which permits coupling of the computer system 100 via a connection 123 to a local-area communications network 122, known as a Local Area Network (LAN). As illustrated in FIG. 1B, the local communications network 122 may also couple to the wide network 120 via a connection 124, which would typically include a so-called “firewall” device or device of similar functionality. The local network interface 111 may comprise an Ethernet circuit card, a Bluetooth® wireless arrangement or an IEEE 802.11 wireless arrangement; however, numerous other types of interfaces may be practiced for the interface 111.

The computer module 101 is typically a server computer in communication with the cameras 127 and 187. In some arrangements, the computer module 101 may be a portable or desktop computing device such as a tablet or a laptop. In arrangements where the eye gaze tracking camera 127 is a head mountable device, the computer module 101 may be implemented as part of the camera 127.

The camera 127 provides a typical implementation of an eye gaze tracking device for collecting and providing eye gaze tracking data. The eye gaze tracking camera 127 may comprise one or more image capture devices suitable for capturing image data, for example one or more digital cameras. The eye gaze tracking camera 127 typically comprises one or more video cameras, each video camera being integral to a head mountable display worn by a viewer of a game. Alternatively, the camera 127 may be implemented as part of computing device or attached to a fixed object such as a computer of furniture.

The camera 187 may comprise one or more image capture devices suitable for capturing video data, for example one or more digital video cameras. The camera 187 typically relates to a plurality of video cameras forming a multi-camera system for capturing video of a scene. The camera 187 may relate to cameras integral to a head mountable display worn by a viewer and/or cameras positioned around the scene, for example around a field on which a game is played. The computer module 101 can control one or more settings of the camera 187 such as angle, pan-tilt-zoom settings, light settings including depth of field, ISO and colour settings, and the like. If the camera 187 is mounted on a dolly, the computer module 101 may control position of the camera 187 relative to the scene.

The cameras 127 and 187 may each be in one of wired or wireless communication, or a combination or wired and wireless communication, with the computer module 101.

The I/O interfaces 108 and 113 may afford either or both of serial and parallel connectivity, the former typically being implemented according to the Universal Serial Bus (USB) standards and having corresponding USB connectors (not illustrated). Storage devices 109 are provided and typically include a hard disk drive (HDD) 110. Other storage devices such as a floppy disk drive and a magnetic tape drive (not illustrated) may also be used. An optical disk drive 112 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the system 100.

The components 105 to 113 of the computer module 101 typically communicate via an interconnected bus 104 and in a manner that results in a conventional mode of operation of the computer system 100 known to those in the relevant art. For example, the processor 105 is coupled to the system bus 104 using a connection 118. Likewise, the memory 106 and optical disk drive 112 are coupled to the system bus 104 by connections 119. Examples of computers on which the described arrangements can be practised include IBM-PC's and compatibles, Sun Sparcstations, Apple Mac™ or like computer systems.

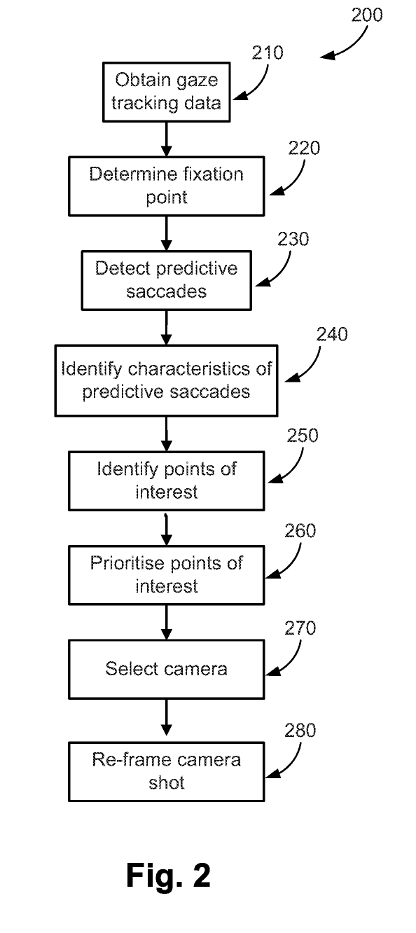

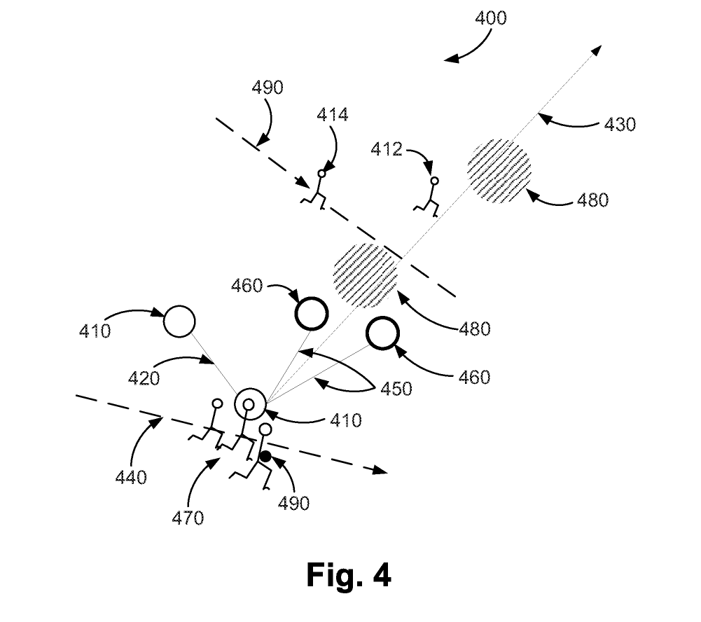

The methods relating to FIGS. 4-10 may be implemented using the computer system 100 wherein the processes of FIG. 2 to be described, may be implemented as one or more software application programs 133 executable within the computer system 100. The software architecture 190 is typically implemented as one or more modules of the software 133. In particular, the steps of the method of FIG. 2 are effected by instructions 131 (see FIG. 1C) in the software 133 that are carried out within the computer system 100. The software instructions 131 may be formed as one or more code modules, each for performing one or more particular tasks. The software may also be divided into two separate parts, in which a first part and the corresponding code modules performs the described methods and a second part and the corresponding code modules manage a user interface between the first part and the user.

The software may be stored in a computer readable medium, including the storage devices described below, for example. The software is loaded into the computer system 100 from the computer readable medium, and then executed by the computer system 100. A computer readable medium having such software or computer program recorded on the computer readable medium is a computer program product. The use of the computer program product in the computer system 100 preferably effects an advantageous apparatus for methods of selecting a camera.

The software 133 is typically stored in the HDD 110 or the memory 106. The software is loaded into the computer system 100 from a computer readable medium, and executed by the computer system 100. Thus, for example, the software 133 may be stored on an optically readable disk storage medium (e.g., CD-ROM) 125 that is read by the optical disk drive 112. A computer readable medium having such software or computer program recorded on it is a computer program product. The use of the computer program product in the computer system 100 preferably effects an apparatus for implementing the arrangements described.

In some instances, the application programs 133 may be supplied to the user encoded on one or more CD-ROMs 125 and read via the corresponding drive 112, or alternatively may be read by the user from the networks 120 or 122. Still further, the software can also be loaded into the computer system 100 from other computer readable media. Computer readable storage media refers to any non-transitory tangible storage medium that provides recorded instructions and/or data to the computer system 100 for execution and/or processing. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computer module 101. Examples of transitory or non-tangible computer readable transmission media that may also participate in the provision of software, application programs, instructions and/or data to the computer module 101 include radio or infra-red transmission channels as well as a network connection to another computer or networked device, and the Internet or Intranets including e-mail transmissions and information recorded on Websites and the like.

The second part of the application programs 133 and the corresponding code modules mentioned above may be executed to implement one or more graphical user interfaces (GUIs) to be rendered or otherwise represented upon the display 114. Through manipulation of typically the keyboard 102 and the mouse 103, a user of the computer system 100 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 117 and user voice commands input via the microphone 180.

FIG. 1C is a detailed schematic block diagram of the processor 105 and a “memory” 134. The memory 134 represents a logical aggregation of all the memory modules (including the HDD 109 and semiconductor memory 106) that can be accessed by the computer module 101 in FIG. 1B.

When the computer module 101 is initially powered up, a power-on self-test (POST) program 150 executes. The POST program 150 is typically stored in a ROM 149 of the semiconductor memory 106 of FIG. 1B. A hardware device such as the ROM 149 storing software is sometimes referred to as firmware. The POST program 150 examines hardware within the computer module 101 to ensure proper functioning and typically checks the processor 105, the memory 134 (109, 106), and a basic input-output systems software (BIOS) module 151, also typically stored in the ROM 149, for correct operation. Once the POST program 150 has run successfully, the BIOS 151 activates the hard disk drive 110 of FIG. 1B. Activation of the hard disk drive 110 causes a bootstrap loader program 152 that is resident on the hard disk drive 110 to execute via the processor 105. This loads an operating system 153 into the RAM memory 106, upon which the operating system 153 commences operation. The operating system 153 is a system level application, executable by the processor 105, to fulfil various high level functions, including processor management, memory management, device management, storage management, software application interface, and generic user interface.

The operating system 153 manages the memory 134 (109, 106) to ensure that each process or application running on the computer module 101 has sufficient memory in which to execute without colliding with memory allocated to another process. Furthermore, the different types of memory available in the system 100 of FIG. 1B must be used properly so that each process can run effectively. Accordingly, the aggregated memory 134 is not intended to illustrate how particular segments of memory are allocated (unless otherwise stated), but rather to provide a general view of the memory accessible by the computer system 100 and how such is used.

As shown in FIG. 1C, the processor 105 includes a number of functional modules including a control unit 139, an arithmetic logic unit (ALU) 140, and a local or internal memory 148, sometimes called a cache memory. The cache memory 148 typically includes a number of storage registers 144-146 in a register section. One or more internal busses 141 functionally interconnect these functional modules. The processor 105 typically also has one or more interfaces 142 for communicating with external devices via the system bus 104, using a connection 118. The memory 134 is coupled to the bus 104 using a connection 119.

The application program 133 includes a sequence of instructions 131 that may include conditional branch and loop instructions. The program 133 may also include data 132 which is used in execution of the program 133. The instructions 131 and the data 132 are stored in memory locations 128, 129, 130 and 135, 136, 137, respectively. Depending upon the relative size of the instructions 131 and the memory locations 128-130, a particular instruction may be stored in a single memory location as depicted by the instruction shown in the memory location 130. Alternately, an instruction may be segmented into a number of parts each of which is stored in a separate memory location, as depicted by the instruction segments shown in the memory locations 128 and 129.

In general, the processor 105 is given a set of instructions which are executed therein. The processor 105 waits for a subsequent input, to which the processor 105 reacts to by executing another set of instructions. Each input may be provided from one or more of a number of sources, including data generated by one or more of the input devices 102, 103, data received from an external source across one of the networks 120, 102, data retrieved from one of the storage devices 106, 109 or data retrieved from a storage medium 125 inserted into the corresponding reader 112, all depicted in FIG. 1B. The execution of a set of the instructions may in some cases result in output of data. Execution may also involve storing data or variables to the memory 134.

The arrangements described use input variables 154, which are stored in the memory 134 in corresponding memory locations 155, 156, 157. The arrangements described produce output variables 161, which are stored in the memory 134 in corresponding memory locations 162, 163, 164. Intermediate variables 158 may be stored in memory locations 159, 160, 166 and 167.

Referring to the processor 105 of FIG. 1C, the registers 144, 145, 146, the arithmetic logic unit (ALU) 140, and the control unit 139 work together to perform sequences of micro-operations needed to perform “fetch, decode, and execute” cycles for every instruction in the instruction set making up the program 133. Each fetch, decode, and execute cycle comprises:

a fetch operation, which fetches or reads an instruction 131 from a memory location 128, 129, 130;

a decode operation in which the control unit 139 determines which instruction has been fetched; and

an execute operation in which the control unit 139 and/or the ALU 140 execute the instruction.

Thereafter, a further fetch, decode, and execute cycle for the next instruction may be executed. Similarly, a store cycle may be performed by which the control unit 139 stores or writes a value to a memory location 132.

Each step or sub-process in the processes of FIG. 2 is associated with one or more segments of the program 133 and is performed by the register section 144, 145, 147, the ALU 140, and the control unit 139 in the processor 105 working together to perform the fetch, decode, and execute cycles for every instruction in the instruction set for the noted segments of the program 133.

The method of selecting a camera may alternatively be implemented in dedicated hardware such as one or more integrated circuits performing the functions or sub functions of FIG. 2. Such dedicated hardware may include graphic processors, digital signal processors, or one or more microprocessors and associated memories.

FIG. 2 is a schematic flow diagram illustrating a method 200 of selecting one or more camera positions. The method 200 is typically implemented as one or more modules of the software application 133 (for example as the software architecture 133), controlled by execution of the processor 105 and stored in the memory 106.

In the arrangement described in relation to FIG. 2 the cameras are selected according to predictive saccade data obtained from one or more viewer, typically expert viewers, at a stadium who are wearing head mounted displays with gaze tracking functionality. The head mounted displays relate to the eye gaze tracking camera 127. The experts wearing the head mounted displays are watching a sports match such as soccer. In the arrangements described, the expert viewers are commentators. Alternative expert viewers include trainers, coaches, players who are off the field, or specialists collecting statistics.

This method 200 commences at an obtaining step 210. In execution of the obtaining step 210 the gaze location module 191, being part of the point of interest prediction architecture 190, obtains data from the video based gaze tracking camera 127.

There are a number of methods of video based eye tracking. One implementation shines an LED light into an eye of the commentator and measures a positional relationship between the pupil and a corneal reflection of the LED. An alternative implementation measures a positional relationship between reference points such as the corner of the eye with the moving iris. The measured positional relationships describe characteristics of the viewer's eye 185 such as saccade directions (320) and fixation locations (310), as shown in the scene 300.

The method 200 progresses under execution of the processor 105 from the obtaining step 210 to a determining step 220. In execution of the determining step 220 the method 200 operates to determines a location or visual fixation point on which the viewer's eye 185 is fixating. The visual fixation point is identified by comparing eye gaze direction data from the gaze location module 191 with a field of view of the camera 187 filming video data of the target objects 170 in the target location 165. In the arrangements described the eye gaze tracking camera 127 and the camera 187 filming the target location 165 are part of a head mounted display which directly maps the camera 187 field of view with the gaze tracking data collected by the gaze tracking camera 187. There are existing head mounted display systems such as Tobii Pro Glasses 2, having both a forward facing camera, relating to the camera 187, and a backward eye gaze tracking device, relating to the camera 127. In some existing systems such as Tobii Pro Glasses 2, the forward and backward facing cameras are already calibrated to map eye gaze tracking data such as fixations 310 and saccades 320 captured through the backward facing camera 127 on to the image plane of the forward facing camera 187. Although existing head mounted display systems are currently used for gaze based research, similar systems are available in consumer head mounted displays where gaze is used for pointing and selecting objects in the real world. Gaze tracking using available systems may be used to practise some of the arrangements described. The consumer head mounted displays are also used to augment virtual data onto the viewer's scene.

Other methods of identifying a user's fixation location (visual fixation point) may be used, for example, when the eye gaze tracking camera 127 is mounted on furniture or a computer in front of the viewer's eye 185. In arrangements where a head mounted display is not used the eye gaze tracking device 127 and the camera 187 filming the target location (which could be anywhere in the stadium) need to be calibrated so that the viewer's fixation location (e.g., 310 of FIG. 3) is mapped to the real world target location 365. Another alternative arrangement uses cameras in the stadium to determine the viewer's gaze direction by calculating distances between the centre line of the face and either eye of the viewer. From the calculated distances between the centre line of the face and either eye a gaze direction is calculated for mapping to a 3D model of the field, generated using multiple cameras around the stadium. Methods are known for 3D mapping of outdoor environments such as sporting areas that could be used to develop a 3D model of a sports stadium. For example, the 3D model may be generated using images captured from multiple cameras around the stadium, for example using techniques such as Simultaneous Localization and Mapping (SLAM) or Parallel Tracking and Mapping (PTAM). In other arrangements, the 3D model may be generated using Light Detection and Ranging (LIDAR)-based techniques or other appropriate techniques.

The method 200 progresses under execution of the processor 105 from the determining step 220 to an detecting step 230. In execution of the detecting step 230, predictive saccades of the viewer are detected and identified. Identifying the predictive saccades is achieved when the saccade recognition module 192 receives data from the gaze location module 191 and identifies the saccades 320, being eye movements, as distinct from the fixations 310, being moments when the eye is still. The saccades are detected via the eye gaze data collected by the eye gaze detection camera 127. In one implementation, the saccades are determined at the step 230 by measuring the angular eye position with respect to time. Some known methods can measure saccades to an angular resolution of 0.1 degrees. A saccade profile can be determined by measuring saccades over a period of time. For example, a saccade profile can be approximated as a gamma function. Taking first derivative of the gamma function yields a velocity profile of the saccade. The predictive saccade detection module 193 then executes to identify predictive saccades using the velocity profiles. Predictive saccades are known to be ten to twenty percent slower than other saccades. In identifying the predictive saccades, the predictive saccade detection module 193 continuously monitors the saccade velocity profile and determines if there a 10-20% drop in saccade velocity (which indicates that the saccade is predictive).

In one arrangement, the predictive saccades identified at the step 230 can be further refined or filtered by noting that the velocity profile of predicative saccades are more skewed in comparison with the velocity profile of other types of other, more symmetric, saccades.

In another arrangement, the step 230 could be further refined by comparing saccade trajectories with a target object. FIG. 4 shows a scene 400 including a target object 470 having a trajectory 440. A plurality of saccades 420 and 450 and a plurality of fixation points 410 are shown in FIG. 4. The saccades 450 end at regions 460. The saccades 450 that divert from the target object trajectory 440 or a location of the target object 470, are more likely to be predictive of the next future point of interest than saccades that follow the target object trajectory 440. Prediction of a future point of interest based on saccades diverting from the trajectory 440 are supported by studies that have found predictive saccades of sports people divert from the trajectory of the ball for a predictive saccade. (See Land, Michael F., and Peter McLeod; “From eye movements to actions: how batsmen hit the ball;” Nature neuroscience 3.12 (2000); 1340-1345 and M. F. Land and S. Furneaux; “The knowledge base of the oculomotor system;” Philosophical Transactions of the Royal Society of London; Series B; Biological Sciences, (1997) Vol. 352, No. 1358, pp. 1231-1239.) When the predictive saccades 450 are identified in execution of step 230, the method 200 progresses under execution of the processor 105 to an identifying step 240.

Characteristics of the identified predictive saccades 450 are identified in execution of the identify characteristics of predictive saccades step 240. In execution of the step 240 the predictive saccade detection module 193 identifies the direction of the predictive saccades 450.

The method 200 progresses under execution of the processor 105 from the identifying step 240 to an identifying step 250. In execution of the identify points of interest step 250 the point of interest module 194 receives the direction of the predictive saccades 450 from the predictive saccade detection module 193 and determines a resultant direction of the predictive saccades 450. The resultant direction is used to determine a future point of interest axis 430. In one implementation, the point of interest module 194 determines an average direction of the saccades. The future point of interest axis 430 indicates a direction in which the viewer's predictive saccades 450 infer future points of interest will occur and represents trajectory data used for determining regions of future interest. The predictive saccades 450 are effectively used to determine points or regions of future interest of the viewer based upon the determined direction of the saccades.

Future points of interest can relate to a location, a player or another type of object on the field. For example future points of interest in FIG. 4 may include one or more of areas 480 on the field that intersect the future point of interest axis 430, a player 412 near the future point of interest axis 430, or a player 414 with a trajectory 490 that intersects with the future point of interest axis 430. Regions or areas of a scene, objects in the scene or trajectories within a scene accordingly all provide examples of future points of interest, also referred to as regions of future interest. Regions of future interest relate to portions of a scene likely to be of increasing relevance to the viewer within a predetermined time frame.

Future points of interest are determined by the point of interest module 194 according to the circumstance of the scene, for example the sport being viewed or a number of people in the scene for surveillance uses. In the arrangements described, a game of soccer is being broadcast, as reflected in FIG. 4. In a soccer game a ball 492 can be passed long distances across the field. Accordingly, the point of interest module 194 identifies future points of interest that are either the empty spaces or areas 480, the player 412 near the future point of interest axis 430, or the player 414 having trajectory data associated with the future point of interest axis 430. In the example of FIG. 4, the trajectory 490 intersects with the future point of interest axis 430.

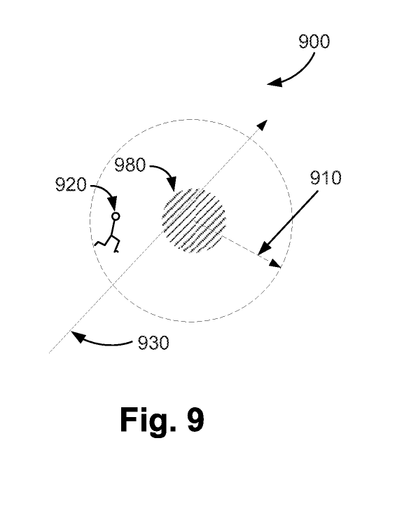

A scene 900 is shown in FIG. 9. In the scene 900, empty spaces are only determined to be future points of interest if the empty spaces intersect a future point of interest axis 930, and there is at least one team member 920 within a predetermined distance threshold 910 associated with the axis 930. In the arrangements described the distance threshold is a distance of 10 metres radius from the centre of an empty space 980 is used. The distance threshold 910 typically varies depending on circumstances of the scene, for example a type of sport, speed of play, level of competition and number and proximity of opposition players. In the example of FIG. 9 the distance threshold 910 ensures that only empty spaces with a team member in close proximity, such that the team member could feasibly reach the empty space to intercept the ball, identify the area 980 as a future point of interest. The distance threshold 910 does not guarantee that the player 920 will be successful in intercepting the ball, only that is the player may possibly intercept the ball, making the empty space 980 a candidate future point of interest. Any empty spaces where team members are beyond the distance threshold 910 are not considered candidate future points of interest.

Referring back to FIG. 2, the method 200 progresses under execution of the processor 105 from the identifying step 250 to a prioritising step 260. The point of interest module 194, in execution of the step 260, prioritises the future points of interest identified in the step 250.

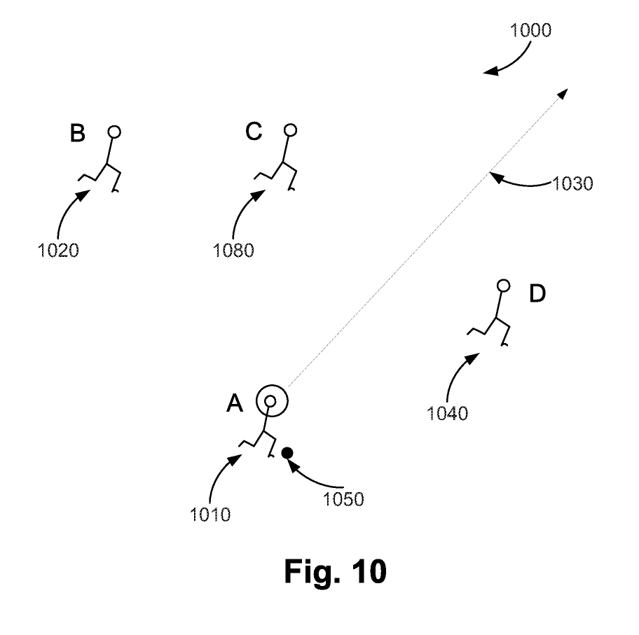

In the arrangements described, the prioritisation at step 260 is determined according to game plays exhibited or detected during play the current game. For example, referring to FIG. 10, if player A 1010 passes a ball 1050 most often to a player B 1020, less often to player C 1080 and only once to player D 1040 in a current game, the method 200 prioritises passing sequences A-B and A-C over A-D at step 260. The method 200 first determines a future point of interest axis 1030 (at step 250) and identifies team members in closest proximity (C and D). The team members C and D are prioritised at step 260 according to a game plays detected during the current game, for example number of times the ball was passed to C or D by the current target, player 1010 in the current game.

In other arrangements, predetermined information such as one or more standard game plays, fitness of a team playing the game or the characteristics of opponents marking team members, are used determine prioritisation of team member sets or prioritisation of future points of interest. A standard game play may for example relate to known play sequences used by or associated with a particular team or players of the game, or plays sequences associated with a particular sport, for example a penalty shoot-out in soccer. Similarly, in surveillance or theatre applications, prioritising future points of interest may respectively depend on previous actions of persons of interest, or of actors.

Referring back to FIG. 2, the method 200 progresses under execution of the processor 105 from the prioritising step 260 to a select step 270. In execution of the select step 270, a camera or multiple cameras are selected according to the prioritised points of interest determined by the point of interest module 194. In the arrangements described, the camera closest to the future point of interest determined to have highest priority is selected, for example a camera nearest player C in FIG. 10. Accordingly, prioritising the future points of interests effectively selects a region of the scene, for which video data is to be captured. The selected region relates to selecting one of the future points of interest.

Selecting a camera at step 270 in some arrangements comprises selecting one camera of a multi-camera system (e.g., where the camera 187 is a multi-camera system). In other arrangements, selecting the camera comprises controlling selection of an parameter of the camera, such as an angle of the camera, such that the camera can capture video data of the highest priority region of future interest, or camera one or more camera settings such as light settings, cropping and/or focus suitable for capturing image data of the highest priority region of future interest.

In another arrangement, the camera selection could be further refined by prioritising cameras according to the time required to re-frame the shot, that is time to change framing settings. Framing settings include one or more of pan, tilt, zoom, move (if on an automated dolly) and depth of field. The benefit of arrangements prioritising future points of interest according to time to re-frame the shot is time saved. If a sport is fast paced any camera that is not able to re-frame fast enough to capture the onset of an action sequence cannot be used.

The method 200 progresses under execution of the processor 105 from the select step 270 to a re-frame step 280. In execution of the reframe step 280 the direction of the camera/s selected in the select camera step 270 are modified so that the future point of interest can be framed. If there are multiple cameras, one or more of the camera directions are modified to generate close up shots, while the one or more other selected cameras are used to generate wider shots. The method 200 accordingly has prepared the selected camera or cameras pre-emptively so to be ready for a predicted future action. The selected camera or cameras capture video data of the selected region of the scene. The video data is captured using any settings or angle selected at step 270.

The video data recorded using the selected camera (and, if appropriate selected camera settings) is sent to the director and is supplementary to pre-set camera feeds the director already has available for broadcast. If the action eventuates as predicted by the method 200 based on the viewer's predictive saccades 450, the director has the selected camera positioned to best capture that action, and can use the captured video data for a broadcast.

In another implementation, at step 270 instead of selecting an existing physical camera, the method 200 generates a virtual camera view to best capture the action at the future point of interest or around a future object of interest. Image data captured using one or more fields of view of one or more selected physical cameras can be used to generate video data of a portion of the scene, referred to as a virtual camera view. A virtual camera view relates to a view of a portion of the scene different to that captured according to the field of view of one of the physical cameras alone.

In some arrangements, a virtual camera system is used to capture a real scene (e.g. sport game or theatre) typically for broadcast. The virtual camera system is more versatile than a standard set of physical cameras because the virtual camera system can be used to general a synthetic view of the scene. The computer system 101 modifies the captured footage to create a synthetic view. Creating a synthetic view can be done, for example, by stitching together overlapping fields of view from more than one camera, cropping the field of view of a single camera, adding animations or annotations to the footage and/or creating a 3D model from the captured footage.

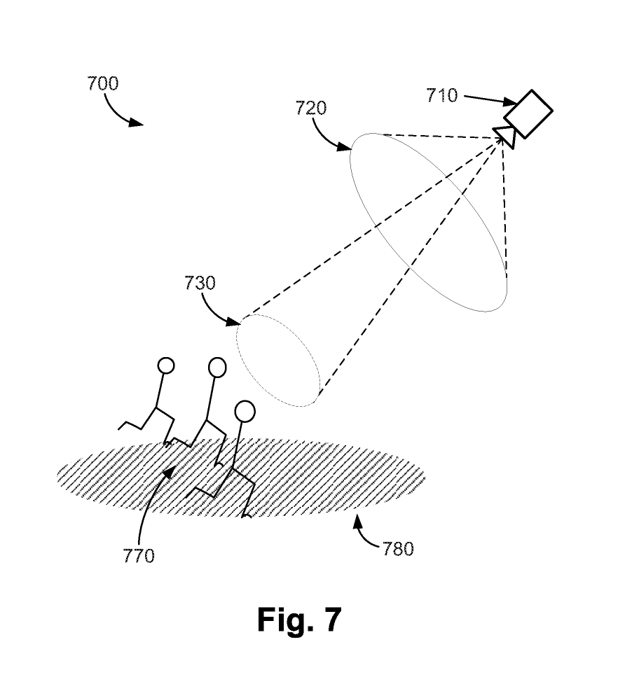

FIG. 7 shows a scene 700 including a target 770 and a future point of interest 780. In this example, to generate a virtual camera view, a single physical camera 710 (for example the camera 187 of FIG. 1A) at a stadium is selected in step 270. The camera 710 is re-framed in step 280 so that the camera 710 in effect provides a new virtual camera view. The reframing for example changes an original wide field of view 720 to a narrower zoomed-in virtual field of view 730 illustrated with a dotted outline in FIG. 7. The re-framed field of view 730 is one example of a new virtual camera view. Single cameras could also be panned, tilted, zoomed, physically moved to re-frame a new virtual camera view. Zoom effects the angle of view of the camera 710, that is the amount of area captured in a shot. In one arrangement, the predictive saccade length would be used to infer the zoom setting. For example, if a short predictive saccade (e.g. 450) is made from a fixation that is a player to a future point of interest which is a player, the zoom would be sufficiently wide to ensure that both players are captured in the camera 710's angle of view. The wide zoom would best capture interaction between the two near players. If the predictive saccade 450 length denotes a real world length greater than 20% of the field, then the zoom of the camera 710 would be narrowed so that the target player 770 only is in shot. In the case where the predictive saccade length is long, filling the frame with the future point of interest player is preferable to trying to also capture the current target object as well. Capturing both players would cause both players to be too small in the shot.

In addition to modifying pan, tilt and zoom of physical cameras, generation of a virtual camera view may relate to modifying settings such depth of field, colour, ISO settings and other image capture settings of the physical cameras. For example, if the virtual camera view relates to moving field of view of a physical camera from a sunlit area of a scene to a shaded area of the scene, ISO settings of the physical camera may be modified.

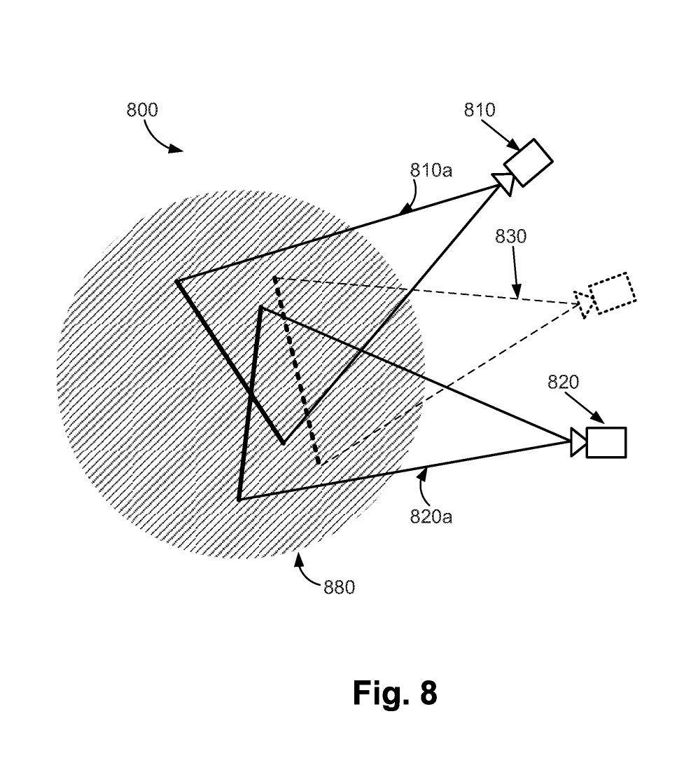

In FIG. 8, a scene 800 includes multiple physical cameras 810 and 820 (for example forming the camera 187 of FIG. 1A) are used to generate an interpolated virtual camera view 830. The physical cameras 810 and 820 and corresponding fields of view 810a and 820a are shown with solid outlines, and a virtual camera view 830 with dotted outlines. The virtual camera view relates to a particular view of the scene 800. In the arrangement of FIG. 8 a new view of the future point of interest, for example in an area 880, can be generated which cannot be captured by any one physical camera (810 or 820) at the stadium. One benefit of virtual camera views is that virtual camera views can frame close up shots of the players as if the virtual camera is at player level, as if on the field during play. Physical cameras cannot be on the field during play.

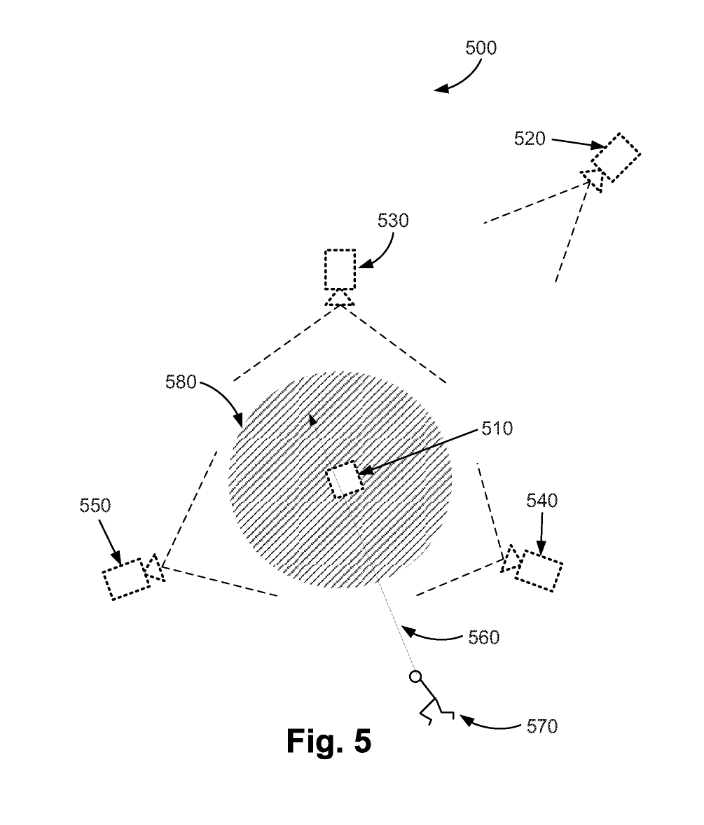

FIG. 5 shows an environment 500 of a stadium. In FIG. 5, a future point of interest 580 may be captured by a number of virtual camera views 510, 520, 530, 540 and 550, determined from physical cameras (not shown), and positioned to capture all potential angles of action at the future point of interest 580. For example, the virtual camera views 510 to 550 may capture footage of a target object 570 along a trajectory 560. The virtual camera views 520 to 550 are generated by interpolating between numbers of physical cameras (not shown) in the stadium. Physical cameras have fields of view that are horizontally or vertically overlapping can be used to generate the virtual camera views 520 to 550. The virtual camera view 520 relates to a distant camera positioned to capture a wide angle view of the future point of interest 580. The virtual camera view 510 relates to a top down camera positioned to capture a plan view of the future point of interest 580. The virtual camera views 530, 540 and 550 are positioned at a lower angle to the view 510 and in closer proximity than the view 520 so as to capture close up and mid shots of the future point of interest 580. The virtual camera views 510, 520, 530, 540 and 550 are beneficial in providing footage because the views 510 to 550 can be positioned on field, whereas physical cameras cannot be on field while the game is in progress. Footage captures from the virtual camera views would be transmitted to the broadcast hub where the director selects which camera feeds are used for broadcast.

In another arrangement the virtual camera views 510, 520, 530, 540 and 550 are prioritised according to two factors, being proximity of each virtual camera view to the future point of interest and/or camera angle of each virtual camera view relative to the future point of interest. The time required to generate virtual camera views is non-trivial and the time available during play of a game is typically relatively short. Accordingly, it is useful to prioritise the generation of virtual camera views.

In a first step the virtual camera views 510 to 550 are prioritised according to proximity to the future point of interest 410. The closer virtual camera views, the views 530, 540 and 550 are assigned higher priority over other camera views as the camera views 530, 540 and 550 are harder to replicate with physical cameras due to being effectively on the field. In a second step, the virtual camera view positioned to capture a front of the approaching future point of interest player is given a higher priority over other camera views. The prioritisation of the virtual camera views 510, 520, 530, 540 and 550 determines an order in which footage captured from each virtual camera view is presented to the director. Given the director's limited ability to take in all camera views and given that virtual camera views may be supplementary to existing pre-set physical camera feeds, the virtual camera views 510, 520, 530, 540 and 550 with the highest priority are elevated to the top of any camera feed list and are more likely to be seen and used by the director.

Sport broadcasters are increasingly presenting graphics for TV audiences which appear to be integrated with the sport field and player actions. For example, broadcast footage may be augmented with graphical content that appears to be printed on a surface of a field on which a game is played. Sport viewers wearing augmented reality head mounted displays at the stadium also benefit from augmented graphical content, for example graphical content providing information about the game. However, time is required to generate graphics and apply the graphics to live sport broadcasts. The arrangements described predict or determine a next future point of interest of viewers of the game. The arrangements described therefore allow a graphics system to pre-emptively generate graphics based on the next future point of interest and present the generated graphics with reduced lag or without lag. The graphics system may for example be implemented as a module of the application 133 and controlled under execution of the processor 105.

Referring to FIG. 4, the players 414 and 412 are on or near future points of interest 480 identified in step 250 and prioritised in 260 and within a distance threshold (for example the threshold 910 of FIG. 9). In one arrangement the locations of the players 412 and 414 trigger a graphics system (for example implemented by a module of the software 133) to pre-emptively start generating graphical content based on the future points of interest, in this example for the players 412 and 414. If the players 412 and 414 become the target object, corresponding graphical content is displayed on the associated broadcast footage.

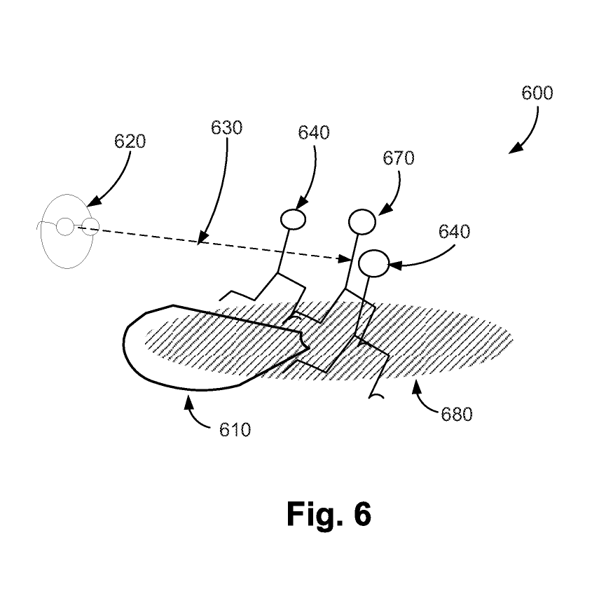

FIG. 6 shows a scene 600 of video data captured subsequent to the scene 400, viewed by a viewer 620. The method 200 has been tracking the gaze of viewer 620 at the stadium for example due to the viewer 620 wearing a head mounted display, a direction 630 of the viewer 620's gaze is known. The method 200 operates to augment the video data with graphical content 610 determined based upon future object of interest. The method 200 positions the augmented graphical content 610 on video footage captured for the future area of interest 680 so that the graphical content 610 is clearly visible to the viewer 620 without being occluded by other objects such as players 640 or target player 670 in a field of view of the viewer 620.

In another arrangement, team and opposition players likely to participate in the next future point of interest are identified, in accordance with step 250. Graphics are then generated for each of future points of interest players. The generated graphic indicate whether the experts watching the game think the corresponding player will participate in the next action event. The insights are derived from expert viewers watching the same match. In this way novice viewers are given further game insights from expert viewers' predictive saccades.

The arrangements described are applicable to the computer and data processing industries and particularly for the video broadcast industries. For example, as referenced above, the arrangements described are suitable for capturing relevant footage for a sports broadcast by predicting where camera footage will be most relevant and providing the footage to the director for selection. The arrangements described are also suitable for capturing video data in other broadcast industries. For example, the arrangements described are suitable for security industries for capturing video data of a suspected person of interest from the point of view of a security person watching a crowd. Alternatively, the arrangements described may be suitable for capturing video data of a theatre setting.

Using predictive saccades to determine a future point of interest and direct select a camera or camera setting accordingly provides an effect in decreased lag in providing video data capturing live action of a scene. Using predictive saccades as described above can also provide an effect of capturing video data of scenes appropriate to live action, and/or broaden scope of live action from predetermined camera positions. Determining a suitable camera or cameras or suitable camera settings or position in advance of an event actually occurring can also reduce cognitive and physical effort of camera operators, and/or reduce difficulties associated with manually adjusting light or camera settings in capturing live footage. In providing video data from a scene such as a game based upon future point of interest of a viewer, final production of live broadcasts can be made more efficient.

The foregoing describes only some embodiments of the present invention, and modifications and/or changes can be made thereto without departing from the scope and spirit of the invention, the embodiments being illustrative and not restrictive For example, one or more of the features of the various arrangements described above may be combined.

1. A computer-implemented method of selecting a camera angle, the method comprising:
determining a visual fixation point of a viewer of a scene using eye gaze data from an eye gaze tracking device;
detecting, from the eye gaze data, one or more saccades from the visual fixation point of the viewer, the one or more saccades indicating a one or more regions of future interest to the viewer;
selecting, based on the detected one or more saccades, a region of the scene; and
selecting a camera angle of a camera, the camera capturing video data of the selected region using the selected angle.

2. The method according to claim 1, wherein the visual fixation point is determined by comparing eye gaze data of the viewer captured from the eye gaze tracking device and video data of the scene captured by the camera.

3. The method according to claim 1, wherein the detected saccades are used to determine a plurality of regions of future interest and selecting the region relates to selecting one or more of the plurality of regions of interest.

4. The method according to claim 1, wherein selecting the camera angle further comprises selecting the camera from a multi-camera system configured to capture video data of the scene.

5. The method according to claim 1, wherein the scene is of a game and selecting the region of the scene based on the one or more saccades comprises prioritising the one or more regions of future interest according to game plays detected during play of the game.

6. The method according to claim 1, wherein the scene is of a game and selecting the region of the scene comprises prioritising the one or more regions of future interest based upon one or more of standard game plays associated with players of the game, fitness of a team playing the game or characteristics of opponents marking players of the game.

7. The method according to claim 1, further comprising determining the plurality of future points of interest based upon determining a direction of each of the one or more saccades,

8. A computer-implemented method of selecting a camera of a multi-camera system configured to capture a scene, the method comprising:
detecting a visual fixation point of a viewer of the scene and one or more saccades of the viewer relative to the visual fixation point using eye gaze data from an eye gaze tracking device;
determining an object of interest in the scene based on at least the detected one or more saccades of the viewer, the object of interest being determined to have increasing relevance to the viewer of the scene; and
selecting a camera of the multi-camera system, the selected camera having a field of view including the determined object of interest in the scene, the camera capturing video data of the determined object of interest.

9. The method according to claim 8, further comprising determining trajectory data associated with the determined object of interest, wherein the camera of the multi-camera system is selected using the determined trajectory data.

10. The method according to claim 8, further comprising determining based on the determined object of interest, and augmenting the video data with the graphical content.

11. The method according to claim 8, wherein selecting the camera of the multi-camera system comprises selecting at least one camera of the multi-camera system and generating a virtual camera view using the selected at least one camera.

12. The method according to claim 8, wherein selecting the camera of the multi-camera system comprises determining a plurality of virtual camera views, the virtual camera views generated by the cameras of the multi-camera system; and prioritising the plurality of virtual camera views based upon proximity of each virtual camera view relative to the determined object of interest.

13. The method according to claim 8, wherein selecting the camera of the multi-camera system comprises determining a plurality of virtual camera views, the virtual camera views generated by the cameras of the multi-camera system; and prioritising the plurality of virtual camera views based on an angle of each virtual camera view relative to the object of interest.

14. The method according to claim 8, wherein the camera is selected based on time required to re-frame the camera to capture video data of the determined object of interest

15. The method according to claim 8, wherein the selecting the camera of the multi-camera system comprises selecting a setting of the camera based upon the determined object of interest.

16. A computer readable medium having a program stored thereon for selecting a camera angle, the program comprising:
code for determining a visual fixation point of a viewer of a scene using eye gaze data from an eye gaze tracking device;
code for detecting, one or more saccades from the visual fixation point of the viewer, the one or more saccades indicating a one or more regions of future interest to the viewer;
code for selecting, based on the detected one or more saccades, a region of the scene; and
code for selecting a camera angle of a second camera, the camera capturing video data of the selected region using the selected angle.

17. Apparatus for selecting a camera angle, the apparatus configured to:
determine a visual fixation point of a viewer of a scene using eye gaze data from an eye gaze tracking device;
detect, from the eye gaze tracking data, one or more saccades from the visual fixation point of the viewer, the one or more saccades indicating a one or more regions of future interest to the viewer;
select, based on the detected one or more saccades, a region of the scene; and
select a camera angle of a camera, the camera capturing video data of the selected region using the selected angle.

18. A system, comprising:
an eye gaze tracking device for detecting eye gaze data of a viewer of a scene;
a multi-camera system configured to capture video data of the scene;
a memory for storing data and a computer readable medium; and
a processor coupled to the memory for executing a computer program, the program having instructions for:
detecting, using the eye gaze tracking data, a visual fixation point of the viewer and one or more saccades of the viewer relative to the visual fixation point;
determining an object of interest in the scene based on at least the detected one or more saccades of the viewer, the object of interest being determined to have increasing relevance to the viewer of the scene; and
selecting a camera of the multi-camera system, the selected camera having a field of view including the determined object of interest in the scene, the second camera capturing video data of the determined object of interest.
